(19) United States
(12) Patent Application Publication
(10) Pub. No.: US 2018/0322116 A1
(43) Pub. Date: Nov. 8, 2018

(54) INTERACTIVE TRANSLATION SYSTEM

(71) Applicant: Jetvox Acoustic Corp., Taoyuan (TW)

(72) Inventors: To-Teng HUANG, Taoyuan (TW); Shih-Yuan CHEN, Taoyuan (TW)

(21) Appl. No.: 15/703,204

(22) Filed: Sep. 13, 2017

(30) Foreign Application Priority Data
May 3, 2017 (TW) 106114717

(51) Int. Cl. G06F 17/28; G10L 15/26; G06F 3/16; G06F 3/0488

(52) U.S. Cl. CPC G06F 17/289; G10L 15/265; H04B 1/38; G06F 3/04883; G06F 3/167

(57) ABSTRACT

An interactive translation system includes a first headset device, a first wireless communication device, a second headset device, and a second wireless communication device. The first and second headset devices receive voices, convert the voices into audio signals, and then transmit the audio signals. The first headset and second headset devices further receive translated audio signals, convert the translated audio signals into translated voices and then outputs. The first and second wireless communication devices receive the audio signals, convert the audio signals into text signals, and transmit the text signals therebetween. The first and second wireless communication devices further translate the text signals to translated text signals, convert the translated text signals into translated audio signals, and send back to the first headset and second headset devices. The interactive translation system increases the transmitting speed, and maintains the interaction between the first and second headset devices under poor network connectivity.

### CROSS-REFERENCE TO RELATED APPLICATION

This non-provisional application claims priority under 35 U.S.C. § 119(a) to Patent Application No. 106114717 filed in Taiwan, R.O.C. on May 3, 2017, the entire contents of which are hereby incorporated by reference.

### BACKGROUND

### Technical Field

The instant disclosure relates to voice translation, in particular, to an interactive translation system.

### Related Art

As the prevailing of globalization and international travel, communications between people that speak different languages has become an inevitable issue. A common way nowadays, is to translate via translation software applications installed on mobile phones, or via Internet-based translation software. However, these approaches usually perform processes of user inquiry, retransmission after translation, or audio output, not capable of achieving the effect of instant bidirectional interactions.

In addition, within the regions under poor network connectivity, the previously mentioned Internet-based translation software may not be able to function normally, thereby failing to provide the translation service.

### SUMMARY

In some embodiments, an interactive translation system includes a first headset device, a first wireless communication device, a second headset device, and a second wireless communication device. The first headset device includes a first audio receiving unit, a first audio transceiver unit and a first audio outputting unit. The first audio receiving unit receives a first voice and converts into a first audio signal. The first audio transceiver unit electrically connects with the first audio receiving unit. The first audio transceiver unit receives and transmits the first audio signal. The first audio transceiver unit further receives externally a second translated audio signal. The first audio outputting unit electrically connects with the first audio transceiver unit. The first audio outputting unit receives the second translated audio signal, converts into a second translated voice and then outputs, wherein the first voice and the second translated voice are of languages identical with or different from each other. The first wireless communication device includes a first transceiver module, a first text-audio converting unit and a first translating unit. The first transceiver module connects in communication with the first audio transceiver unit and receives the first audio signal. The first text-audio converting unit electrically connects with the first transceiver module and receives the first audio signal. The first text-audio converting unit converts the first audio signal into a first text signal and sends back to the first transceiver module for wireless transmitting. The first transceiver module further wirelessly and receives externally a second text signal. The first translating unit electrically connects with the first transceiver module. The first translating unit receives the second text signal and translates into a first translated text signal. The first text-audio converting unit further electrically connects with the first translating unit and receives the first translated text signal. The first text-audio converting unit converts the first translated text signal into the second translated audio signal and sends back to the first transceiver module. The first transceiver module further transmits the second translated audio signal to the first audio transceiver unit. The second headset device includes a second audio receiving unit, a second audio transceiver unit and a second audio outputting unit. The second audio receiving unit receiving unit receives a second voice and converts into a second audio signal. The second audio transceiver unit electrically connects with the second audio receiving unit. The second audio transceiver unit receives and transmits the second audio signal. The second audio transceiver unit further receives externally a first translated audio signal. The second audio outputting unit electrically connects with the second audio transceiver unit. The second audio outputting unit receives the first translated audio signal, converts into a first translated voice and outputs, wherein the second voice and the first translated voice are of languages identical with or different from each other. The second wireless communication device includes a second transceiver module, a second text-audio converting unit and a second translating unit. The second transceiver module connects in communication with the second audio transceiver unit and receives the second audio signal. The second text-audio converting unit electrically connects with the second transceiver module and receives the second audio signal. The second text-audio converting unit converts the second audio signal into the second text signal and sends back to the second transceiver module for wireless transmitting. The second transceiver module connects in wireless communication with the first transceiver module and receives the first text signal. The second translating unit electrically connects with the second transceiver module. The second translating unit receives the first text signal and translates into a first translated text signal. The second text-audio converting unit electrically connects with the second translating unit and receives the first translated text signal. The second text-audio converting unit converts the first translated text signal into the first translated audio signal and sends back to the second transceiver module. The second transceiver module transmits the first translated audio signal to the first audio transceiver unit.

In some embodiments, the first transceiver module and the second transceiver module respectively comprise a Wi-Fi-direct unit for connecting in wireless communication therebetween.

In some embodiments, the first transceiver module and the first audio transceiver unit respectively comprises a Bluetooth unit for connecting in wireless communication therebetween. And in some embodiments, the first transceiver module and the first audio transceiver unit are connected in wired communication.

In some embodiments, the first wireless communication device further comprises a first display unit to display the second translated text signal, and the second wireless communication device further comprises a second display unit to display the first translated text signal. In addition, the first display unit is a touch display device to generate a handwriting text signal, the first transceiver module electrically connects with the first display unit, and the first transceiver module receives the handwriting text signal and wirelessly transmits to the second transceiver module.

In an embodiment, an interactive translation system includes a first headset device, a first wireless communication device, a second headset device, and a second wireless communication device. The first headset device includes a first audio receiving unit, a first audio transceiver unit and a first audio outputting unit. The first audio receiving unit receives a first voice, and converting into a first audio signal. The first audio transceiver unit electrically connects with the first audio receiving unit. The first audio transceiver unit receives the first audio signal and then outputs. The first audio transceiver unit further receives externally a second translated audio signal. The first audio outputting unit electrically connects with the first audio transceiver unit. The first audio outputting unit receives the second translated audio signal, converting into a second translated voice and then outputs, wherein the first voice and the second translated voice are of languages identical with or different from each other. The first wireless communication device includes a first transceiver module, a first text-audio converting unit and a first translating unit. The first transceiver module connects in communication with the first audio transceiver unit and receives the first audio signal. The first text-audio converting unit electrically connects with the first transceiver module and receives the first audio signal. The first text-audio converting unit converts the first audio signal into a first text signal. The first translating unit electrically connects with the first text-audio converting unit, receives the first text signal and then translates into a first translated text signal. The first transceiver module further electrically connects with the first translating unit, receives the first translated text signal and then transmits wirelessly. The first transceiver module further receives externally a second translated text signal, and then transmits to the first text-audio converting unit. The first text-audio converting unit converts the second translated text signal into the second translated audio signal and sends back to the first transceiver module. The first transceiver module transmits the second translated audio signal to the first audio transceiver unit. The second headset device includes a second audio receiving unit, a second audio transceiver unit and a second audio outputting unit. The second audio receiving unit receives a second voice and converting into a second audio signal. The second audio transceiver unit electrically connects with the second audio receiving unit, receives the second audio signal and then transmits. The second audio transceiver unit further receives externally a first translated audio signal. The second audio outputting unit electrically connects with the second audio transceiver unit. The second audio outputting unit receives the first translated audio signal and converts into a first translated voice and then outputs, wherein the second voice and the first translated voice are of languages identical with or different from each other. The second wireless communication device includes a second transceiver module, a second text-audio converting unit and a second translating unit. The second transceiver module connects in communication with the second audio transceiver unit and receives the second audio signal. The second text-audio converting unit electrically connects with the second transceiver module, receives the second audio signal and converts into a second text signal. The second translating unit electrically connects with the second text-audio converting unit, receives the second text signal, and then translates into the second translated text signal. The second transceiver module further electrically connects with the second translating unit, receives the second translated text signal, and then wirelessly transmits to the second transceiver module. The second transceiver module further connects in wireless communication with the first transceiver module, receives the first translated text signal, and then transmits to the second text-audio converting unit. The second text-audio converting unit converts the first translated text signal into the first translated audio signal and sends back to the second transceiver module. The second transceiver module further transmits the first translated audio signal to the second audio transceiver unit.

In some embodiments, the first transceiver module and the first audio transceiver unit respectively comprises a Bluetooth unit for connecting in wireless communication therebetween. In some embodiments, the first transceiver module and the first audio transceiver unit may be connected in wired communication.

In some embodiments, the first wireless communication device further includes a first display unit to display the second translated text signal, and the second wireless communication device further includes a second display unit to display the first translated text signal. In addition, the first display unit is a touch display device to generate a handwriting text signal, the first translating unit electrically connects with the first display unit and receives the handwriting text signal, and the first translating unit translates the handwriting text signal into the first translated text signal and then transmits to the first transceiver module.

In an embodiment, an interactive translation system includes a first headset device, a first wireless communication device, a cloud translation server, a second headset device, and a second wireless communication device. The first headset device includes a first audio receiving unit, a first audio transceiver unit and a first audio outputting unit. The first audio receiving unit receives a first voice and converts into a first audio signal. The first audio transceiver unit electrically connects with the first audio receiving unit. The first audio transceiver unit receives and transmits the first audio signal. The first audio transceiver unit further receives externally a second translated audio signal. The first audio outputting unit electrically connects with the first audio transceiver unit. The first audio outputting unit receives the second translated audio signal, converts into a second translated voice and then outputs, wherein the first voice and the second translated voice are of languages identical with or different from each other. The first wireless communication device includes a first transceiver module and a first text-audio converting unit. The first transceiver module connects in communication with the first audio transceiver unit, and receives the first audio signal for wireless transmitting. The first transceiver module further wirelessly receives and wirelessly transmits a first translated text signal corresponding to the first audio signal. The first transceiver module also wirelessly receives a second translated text signal. The first text-audio converting unit electrically connects with the first transceiver module. The first text-audio converting unit receives the second translated text signal, converts into a second translated audio signal and sends back to first transceiver module. The first transceiver module further transmits the second translated audio signal to the first audio transceiver unit. The cloud translation server connects in wireless communication with the first transceiver module. The cloud translation server wirelessly receives the first audio signal, translates and converts into the first translated text signal. The cloud translation server further wirelessly transmits the first translated text signal to the first transceiver module. The second headset device includes a second audio receiving unit, a second audio transceiver unit and a second audio outputting unit. The second audio receiving unit receives a second voice and converts into a second audio signal. The second audio transceiver unit electrically connects with the second audio receiving unit. The second audio transceiver unit receives and transmits the second audio signal. The second audio transceiver unit further receives externally a first translated audio signal. The second audio outputting unit electrically connects with the second audio transceiver unit. The second audio outputting unit receives the first translated audio signal, converts into a first translated voice and then outputs, wherein the second voice and the first translated voice are of languages identical with or different from each other. The second wireless communication device includes a second transceiver module and a second text-audio converting unit. The second transceiver module connects in communication with the second audio transceiver unit and receives the second audio signal. The second transceiver module further connects in communication with the cloud translation server for wireless transmitting the second audio signal to the cloud translation server. The cloud translation server translates and converts the second audio signal into the second translated text signal and then sends back to the second transceiver module. The second transceiver module further connects in wireless communication with the first transceiver module. The second transceiver module wirelessly receives the first translated text signal and wirelessly transmits the second translated text signal. The second text-audio converting unit electrically connects with the second transceiver module. The second text-audio converting unit receives the first translated text signal, converts into a first translated audio signal and then sends back to the second transceiver module. The second transceiver module transmits the first translated audio signal to the second audio transceiver unit.

In some embodiments, the first transceiver module and the second transceiver module respectively comprises a Wi-Fi unit for connecting in wireless communication therebetween. In addition, the Wi-Fi unit connects in wireless communication with a wireless router, and the wireless router connects in wireless communication with the cloud translation server.

In some embodiments, the first transceiver module and the second transceiver module respectively comprise a long-range wireless transceiver, and the long-range wireless transceiver connects in wireless communication with the cloud translation server.

In some embodiments, the first transceiver module and the first audio transceiver unit respectively comprises a Bluetooth unit for connecting in wireless communication therebetween. In other embodiments, the first transceiver module and the first audio transceiver unit are connected in wired communication.

In some embodiments, the first headset device and the second headset device respectively comprise a first identification unit and a second identification unit, which respectively generates a first identification information and a second identification information. The first audio transceiver unit electrically connects with the first identification unit. The first audio transceiver unit receives the first identification information and transmits to the first transceiver module. The second audio transceiver unit electrically connects with the second identification unit. The second audio transceiver unit receives the first identification information and transmits to the second transceiver module. The first wireless communication device and the second wireless communication device respectively comprise a first authentication unit and a second authentication unit. The first authentication unit electrically connects with the first transceiver module and receives the first identification information. The second authentication unit electrically connects with the second transceiver module and receives the second identification information. The first transceiver module transmits the first audio signal to the cloud translation server when the first authentication unit determines that the first identification information is correct. The second transceiver module transmits the second audio signal to the cloud translation server when the second authentication unit determines that the second identification information is correct.

In some embodiments, the first wireless communication device further comprises a first display unit to display the second translated text signal, and the second wireless communication device further comprises a second display unit to display the first translated text signal. In addition, the first display unit is a touch display device to generate a handwriting text signal. The first transceiver module electrically connects with the first display unit. The first transceiver module receives and wirelessly transmits the handwriting text signal to the cloud translation server.

In some embodiments, the first audio signal, the second audio signal, the first translated audio signal and the second translated audio signal are of an uncompressed audio coding format or a compressed audio coding format.

In some embodiments, the first audio receiving unit and the second audio receiving unit respectively comprises a microphone, wherein the microphone is a micro-electromechanical systems microphone or a bone-conduction microphone.

In brief, according to the embodiments of the instant disclosure, the first wireless communication device and the second wireless communication device of the interactive translation system connect in communication with each other. Text signals are utilized to transmit in between to lower data transmission quantity and accelerate the transmission speed. In addition, the interactive translation system maintains the interaction between the first headset device and the second headset device under poor network connectivity.

### BRIEF DESCRIPTION OF THE DRAWINGS

The disclosure will become more fully understood from the detailed description given herein below for illustration only, and thus not limitative of the disclosure, wherein:

FIG. 1 illustrates an explanatory diagram regarding an operating status of an interactive translation system according to a first embodiment of the instant disclosure;

FIG. 2 illustrates a block diagram of the interactive translation system according to the first embodiment of the instant disclosure;

FIG. 3 illustrates another assembly block diagram within an interactive translation system of the instant disclosure;

FIG. 4 illustrates an operation flowchart of the interactive translation system according to the first embodiment of the instant disclosure;

FIG. 5 illustrates an explanatory diagram regarding an operating status of an interactive translation system according to a second embodiment of the instant disclosure;

FIG. 6 illustrates a block diagram of the interactive translation system according to the second embodiment of the instant disclosure;

FIG. 7 illustrates an operation flowchart of the interactive translation system according to the second embodiment of the instant disclosure;

FIG. 8 illustrates an explanatory diagram regarding an operating status of an interactive translation system according to a third embodiment of the instant disclosure;

FIG. 9 illustrates a block diagram of the interactive translation system according to the third embodiment of the instant disclosure;

FIG. 10 illustrates an explanatory block diagram of the interactive translation system under another transmission method according to the third embodiment of the instant disclosure;

FIG. 11 illustrates an operation flowchart of the interactive translation system according to the third embodiment of the instant disclosure; and

FIG. 12 illustrates an explanatory diagram regarding an operating status of an interactive translation system according to a fourth embodiment of the instant disclosure.

### DETAILED DESCRIPTION

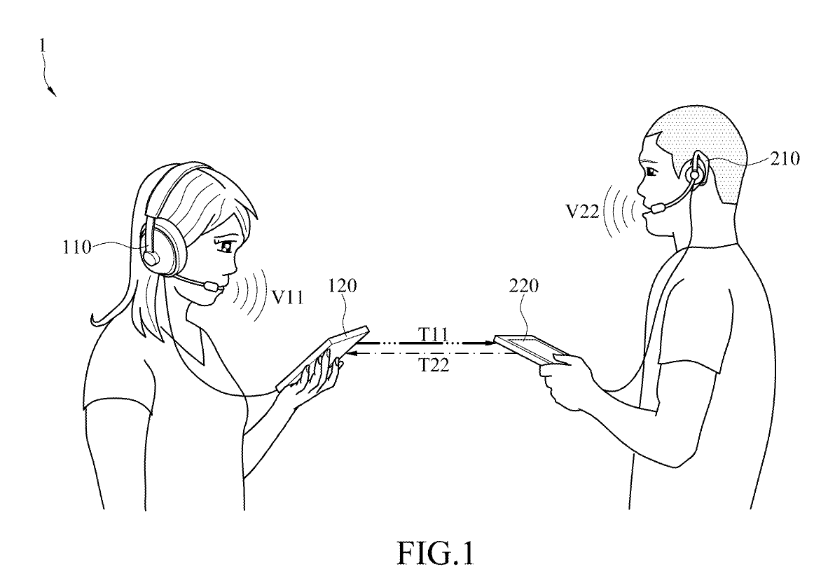

Please refer to FIG. 1, which illustrates an explanatory diagram regarding an operating status of an interactive translation system according to a first embodiment of the instant disclosure. As shown in FIG. 1, the interactive translation system 1 of the first embodiment includes a first headset device 110, a first wireless communication device 120, a second headset device 210 and a second wireless communication device 220. The users of a first voice V11 and a second voice V22, may wirelessly communicate with each other through the first wireless communication device 120 and the second wireless communication device 220 respectively, and transmit and translate a first text signal T11 and a second text signal T22, to achieve the function of interactive translation and lower data transmission quantity.

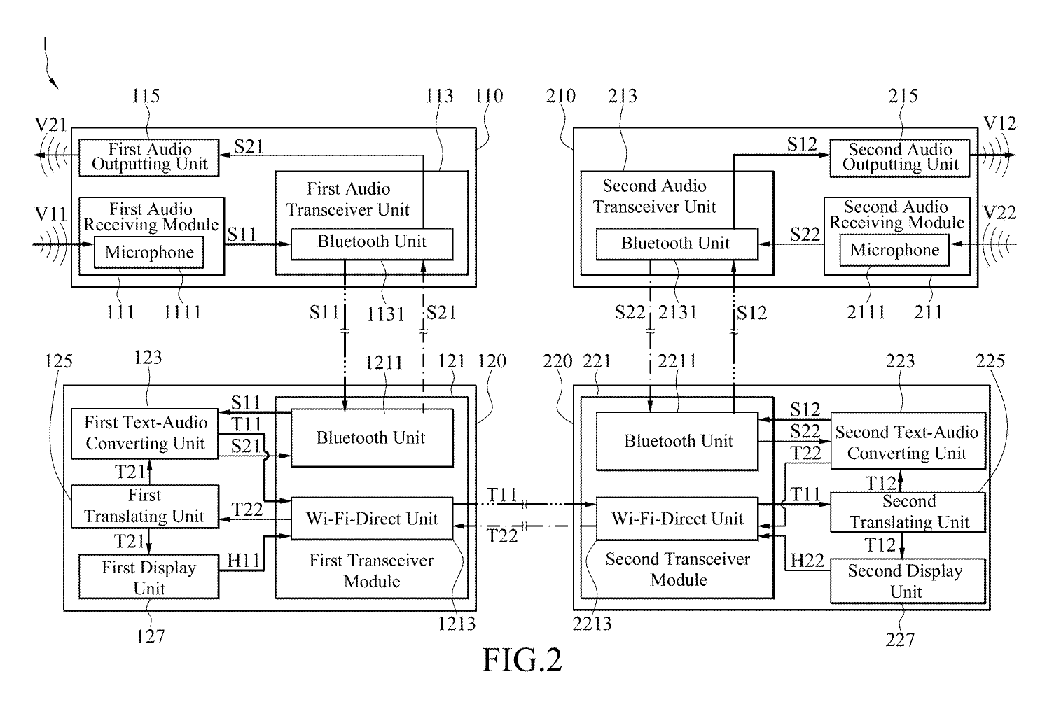

FIG. 2 illustrates a block diagram of the interactive translation system according to the first embodiment of the instant disclosure. As shown in FIG. 2, detailed descriptions are to introduce the ways of wireless communications between the first headset device 110, the first wireless communication device 120, the second headset device 210 and the second wireless communication device 220, and between the first wireless communication device 120 and the second wireless communication device 220.

The first headset device 110 includes a first audio receiving unit 111, a first audio transceiver unit 113 and a first audio outputting unit 115. The first audio receiving unit 111 receives the first voice V11, and converts into a first audio signal S11. Herein the conversion between the first voice V11 and the first audio signal S11 is a conversion between sound and electrical signal, with limitation to the converting means of generating the first audio signal S11 and the converted format of the first audio signal S11. The first audio transceiver unit 113 electrically connects with the first audio receiving unit 111. The first audio transceiver unit 113 receives the first audio signal S11 and transmits to the first wireless communication device 120. The first audio transceiver unit 113 further receives a second translated audio signal S21 transmitted from the first wireless communication device 120. The first audio outputting unit 115 electrically connects with the first audio transceiver unit 113. The first audio outputting unit 115 receives the second translated audio signal S21, converts into a second translated voice V21 and then outputting. Understandably, the conversion between the second translated voice V21 and the second translated audio signal S21 is a conversion between sound and electrical signal, without limitation to the converting means of the second translated audio signal S21 and the format of the second translated audio signal S21. Herein the first voice V11 and the second translated voice V21 are of languages identical with or different from each other.

The first wireless communication device 120 includes a first transceiver module 121, a first text-audio converting unit 123 and a first translating unit 125. The first transceiver module 121 connects in communication with the first audio transceiver unit 113 and receives the first audio signal S11. The first text-audio converting unit 123 electrically connects with the first transceiver module 121 and receives the first audio signal S11. The first text-audio converting unit 123 converts the first audio signal S11 into the first text signal T11, and sends back to the first transceiver module 121 for wirelessly transmitting to the second wireless communication device 220. The first transceiver module 121 further wirelessly receives a second text signal T22 from the second wireless communication device 220. The first translating unit 125 electrically connects with the first transceiver module 121. The first translating unit 125 receives the second text signal T22 and translates into a first translated text signal T21. The first text-audio converting unit 123 further electrically connects with the first translating unit 125 and receives the first translated text signal T21. The first text-audio converting unit 123 converts the first translated text signal T21 into the second translated audio signal S21 and sends back to the first transceiver module 121. The first transceiver module 121 further transmits the second translated audio signal S21 to the first audio transceiver unit 113.

The second headset device 210 includes a second audio receiving unit 211, a second audio transceiver unit 213 and a second audio outputting unit 215. The second audio receiving unit 211 receives the second voice V22 and converts into a second audio signal S22. The second audio transceiver unit 213 electrically connects with the second audio receiving unit 211, and receives and transmits the second audio signal S22 to the second wireless communication device 220. The second audio transceiver unit 213 further receives a first translated audio signal S12 transmitted from the second wireless communication device 220. The second audio outputting unit 215 electrically connects with the second audio transceiver unit 213. The second audio outputting unit 215 receives the first translated audio signal S12 and converts into a first translated voice V12 and then outputting. Understandably, either the conversion between the second voice V22 and the second audio signal S22, or the conversion between the first translated voice V12 and the first translated audio signal S12 is a conversion between sound and electrical signal, without limitation to the converting means and the formats of the audio signals. The second voice V22 and the first translated voice V12 are of languages identical with or different from each other.

The second wireless communication device 220 includes a second transceiver module 221, a second text-audio converting unit 223 and a second translating unit 225. The second transceiver module 221 connects in communication with the second audio transceiver unit 213 and receives the second audio signal S22. The second text-audio converting unit 223 electrically connects with the second transceiver module 221 and receives the second audio signal S22. The second text-audio converting unit 223 converts the second audio signal S22 into the second text signal T22 and sends back to the second transceiver module 221 for wirelessly transmitting to the first wireless communication device 120. The second transceiver module 221 is further connected in wireless communication with the first transceiver module 121 and receives the first text signal T11. The second translating unit 225 electrically connects with the second transceiver module 221. The second translating unit 225 receives the first text signal T11 and translates into a first translated text signal T12. The second text-audio converting unit 223 electrically connects with the second translating unit 225 and receives the first translated text signal T12. The second text-audio converting unit 223 converts the first translated text signal T12 into the first translated audio signal S12 and sends back to the second transceiver module 221. The second transceiver module 221 further transmits the first translated audio signal S12 to the first audio transceiver unit 213.

Herein, the second transceiver module 121 and the second transceiver module 221 communicate wirelessly and transmit with the first text signal T11 and the second text signal T12. As the file contents of the text signals are mainly pure text messages, the file sizes thereof are smaller than the file sizes of audio signals, thereby lowering data transmission quantity and dramatically accelerate the transmission speed. As shown in FIG. 2, in some embodiments, the first transceiver module 121 and the second transceiver module 221 respectively include a Wi-Fi-Direct unit 1213, 2213 for connecting in wireless communication therebetween. Therefore, both sides can still maintain wireless communication and perform the interactive translation function under poor network connectivity.

In some embodiments, the first wireless communication device 120 further includes a first display unit 127. The first display unit 127 electrically connects with the first translating unit 125, and receives the second translated text signal T21 to display thereon. The second wireless communication device 220 further includes a second display unit 227. The second display unit 227 electrically connects with the second translating unit 225, and receives the first translated text signal T12 to display thereon. The display unit displays the translated text signals thereon to provide the interactive translation function within poor soundstage environments, such as shopping malls and factories.

In addition, the first display unit 127 and/or the second display unit 227 may be a touch display device, and the user may use an input unit such a finger or a stylus touch pen to generate handwriting text signals H11/H22. Herein, the formats of the handwriting text signals H11/H22 are identical with the first text signal T11 and the second text signal T22, namely the handwriting text signals H11/H22 are wirelessly transmittable as the first text signal T11 and the second text signal T22 respectively. The first transceiver module 121 electrically connects with the first display unit 127. The first transceiver module 121 receives the handwriting text signal H11 and wirelessly transmits to the second transceiver module 221. The transmission means of the text signals H22 are similar and detailed description is omitted herein. Therefore, text input embodiments are introduced to achieve interactive translation in low SNR (Signal-to-Noise Ratio) environments. Such method provides services to the deaf and the mute without pairing the headset devices.

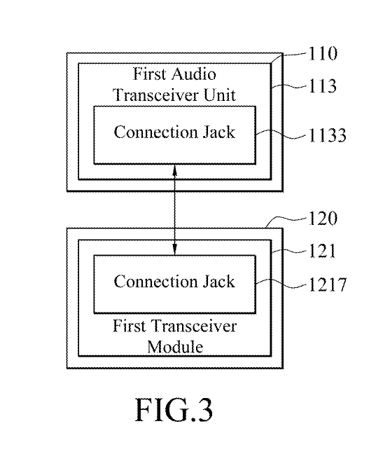

FIG. 3 illustrates another assembly block diagram within an interactive translation system of the instant disclosure. As shown in FIG. 2, the first transceiver module 121 and the first audio transceiver unit 113 respectively include a Bluetooth unit 1211, 1131 for connecting in wireless communication therebetween. While as shown in FIG. 3, the first transceiver module 121 and the first audio transceiver unit 113 are connected in wired communication. For example, the first transceiver module 121 and the first audio transceiver unit 113 respectively include a connection jack 1217, 1137. The connection jack 1217, 1137 may be 3.5 mm plug jack, micro-USB electrical connector, or Lightning electrical connector. Therefore, the first headset device 110 and the first wireless communication device 120 may connect in communication with each other through an audio cable or a USB cable. What introduced above is for illustration purposes only, and should not become limitations to the instant disclosure. The second transceiver module 221 and the second audio transceiver unit 213 may include a Bluetooth unit 2211, 2131 respectively, or connect in wired communication with each other. In the embodiment shown in FIG. 2, the Bluetooth units 1211, 1131 and the Bluetooth units 2211, 2131 needs pairing with each other to connect in communication without interferences to each other.

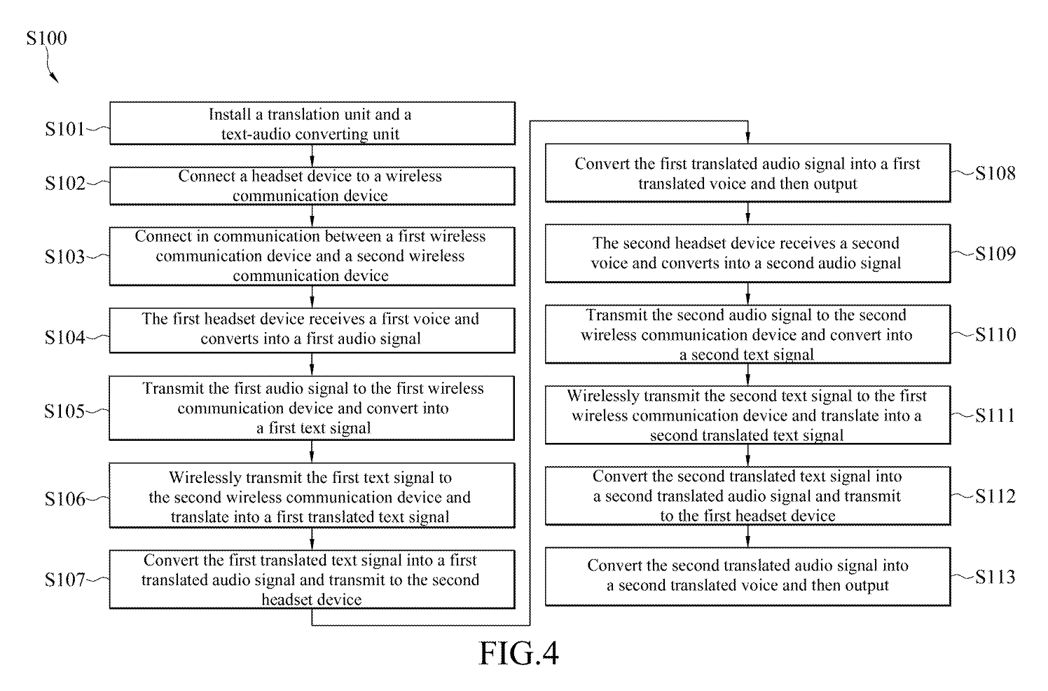

FIG. 4 illustrates an operation flowchart of the interactive translation system according to the first embodiment of the instant disclosure. As shown in FIG. 4, in an operation flowchart S100 of the interactive translation system according to the first embodiment, first, Step S101 is to install a translation unit and a text-audio converting unit in the first wireless communication device 120 and the second wireless communication device 220 respectively. Herein the translation unit and the text-audio converting unit may be realized in the forms of application programs, or be carried on storage card(s) installed in the first wireless communication device 120 and the second wireless communication device 220 respectively. The translation unit and the text-audio converting unit may further allow user settings of target language type(s) for translation. Next, in Step S102, connect a headset device and a wireless communication device. Herein by means of Bluetooth pairing communication or wired communication connection, the first headset device 110 connects with the first wireless communication device 120, while the second headset device 210 connects with the second wireless communication device 220.

In Step S103, connect in communication between the first wireless communication device 120 and the second wireless communication device 220. In Step S104, the first audio receiving unit 111 of the first headset device 110 receives the first voice V11, and acoustoelectrically converts (sound signal to electrical signal) into the first audio signal S11. Herein, a component to receive the first voice V11 is microphone 1111. For a smaller volume and the clearer sound, the microphone 1111 may be realized by a micro-electromechanical systems microphone or a bone-conduction microphone. What introduced herein is for illustration purposes only, and should not become limitations to the instant disclosure. In Step S105, the first audio transceiver unit 113 of the first headset device 110 transmits the first audio signal S11 to the first transceiver module 121 of the first wireless communication device 120. The first text-audio converting unit 123 of the first wireless communication device 120 receives the first audio signal S11 and converts into the first text signal T11.

In Step S106, the first wireless communication device 120 wirelessly transmits the first text signal T11 to the second wireless communication device 220. The second translating unit 215 of the second wireless communication device 220 receives the first text signal T11, and translates into the first translated text signal T12 in a language corresponding to the language type setting of the second wireless communication device 220. In Step S107, the second text-audio converting unit 223 of the second wireless communication device 220 receives the first translated text signal T12, and converts into the first translated audio signal S12. The second transceiver module 221 receives the first translated text signal S12 and transmits to the second headset device 210. In Step S108, the second audio outputting unit 215 of the second headset device 220 electroacoustically converts (electrical signal to sound signal) the first translated audio signal S12 into the first translated voice V12, and then outputs.

The steps from Step S109 to Step S113, are reverse processes approximately similar to the steps from Step S104 to Step S108, namely in the order from Step S108 back to Step S104. In Step S109, the second audio receiving unit 211 of the second headset device 210 receives the second voice V22, and acoustoelectrically converts into the second audio signal S22. Identically, the microphone 2111 of the second audio receiving unit 211 receives the second voice V22, wherein the microphone 2111 may be realized by utilizing a micro-electromechanical systems microphone or a bone-conduction microphone. In Step S110, the second audio transceiver unit 213 of the second headset device 210 transmits the second audio signal S22 to the second transceiver module 221 of the second wireless communication device 220. The second text-audio converting unit 223 of the second wireless communication device 220 receives the second audio signal S22, and converts into the second text signal T22.

In Step S111, the second wireless communication device 220 wirelessly transmits the second text signal T22 to the first wireless communication device 120. The first translating unit 115 of the first wireless communication device 120 receives the second text signal T22, and translates into the second translated text signal T21 in a language corresponding to the language type setting of the first wireless communication device 120. In Step S112, the first text-audio converting unit 123 of the first wireless communication device 120 receives the second translated text signal T21, and converts into the second translated audio signal S21. The first transceiver module 121 receives the second translated audio signal S21 and transmits to the first headset device 110. In Step S113, the first audio outputting unit 115 of the first headset device 120 electroacoustically converts the second translated audio signal S21 into the second translated voice V21, and then outputs.

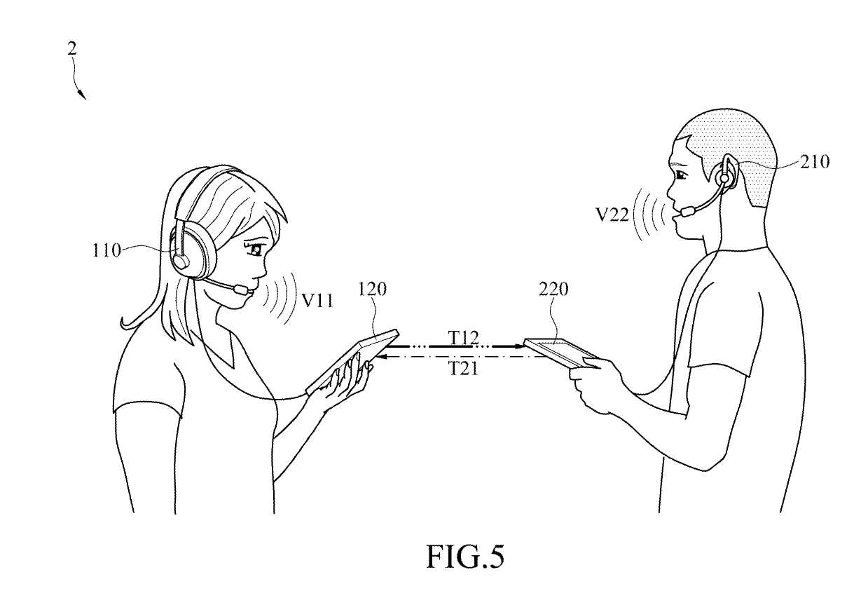

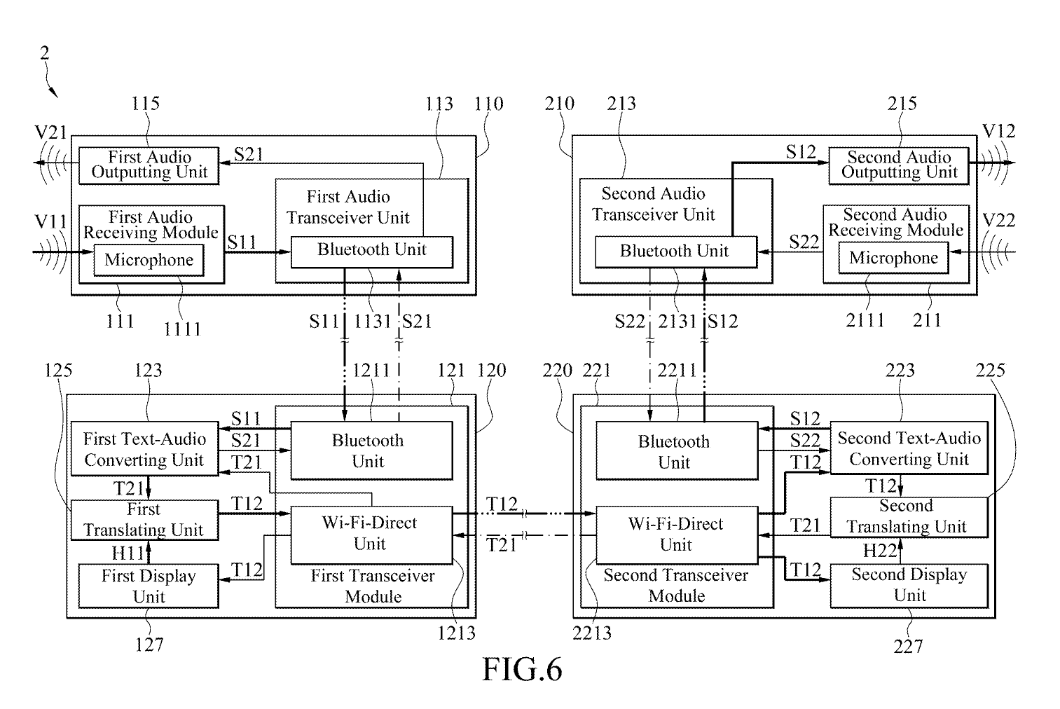

FIG. 5 illustrates an explanatory diagram regarding an operating status of an interactive translation system according to a second embodiment of the instant disclosure. As shown in FIG. 5, FIG. 5 is similar to FIG. 1, yet the transmissions of text signals in FIG. 5 are different from the first embodiment. In FIG. 5, what transmitted between the first wireless communication device 120 and the second wireless communication device 220, are the first translated text signal T12 and the second translated text signal T21. Detailed components and signal transmissions thereof are further introduced in FIG. 6.

FIG. 6 illustrates a block diagram of the interactive translation system according to the second embodiment of the instant disclosure. As shown in FIG. 6, an interactive translation system 2 of the second embodiments similarly includes a first headset device 110, a first wireless communication device 120, a second headset device 210, and a second wireless communication device 220, wherein the first wireless communication device 120 and the second wireless communication device 220 are connected in wireless communication. In FIG. 6, the signal transmissions and the operating processes of the first wireless communication device 120 and the second wireless communication device 220 are the main differences from the first embodiment. In the second embodiment, the first wireless communication device 120 includes a first transceiver module 121, a first text-audio converting unit 123 and a first translating unit 125. The first transceiver module 121 connects in communication with the first audio transceiver unit 113 of the first headset device 110, and receives the first audio signal S11. The first text-audio converting unit 123 electrically connects with the first transceiver module 121 and receives the first audio signal S11. The first text-audio converting unit 123 converts the first audio signal S11 into the first text signal T11. The first translating unit 125 electrically connects with the first text-audio converting unit 123, receives the first text signal T11 and translates into the first translated text signal T12. The first transceiver module 121 further electrically connects with the first translating unit 125, receives the first translated text signal T12 and wirelessly transmits to the second wireless communication device 220. The first transceiver module 121 further receives the second translated text signal T21 transmitted from the second wireless communication device 220, and transmits to the first text-audio converting unit 123. The first text-audio converting unit 123 converts the second translated text signal T21 into the second translated audio signal S21, and send back to the first transceiver module 121. The first transceiver module 121 transmits the second translated audio signal S21 to the first audio transceiver unit 113 of the first headset device, to proceed with the following steps of electroacoustically converting and outputting.

The second wireless communication device 220 includes a second transceiver module 221, a second text-audio converting unit 223 and a second translating unit 225. The second transceiver module 221 connects in communication with the second audio transceiver unit 213, and receives the second audio signal S22 from the second headset device 210. The second text-audio converting unit 223 electrically connects with the second transceiver module 221, receives the second audio signal S22, and converts into the second text signal T22. The second translating unit 225 electrically connects with the second text-audio converting unit 223, receives the second text signal T22 and translates into the second translated text signal T21. The second transceiver module 221 further electrically connects with the second translating unit 225, receives the second translated text signal T21 and then wirelessly transmits to the second transceiver module 221. The second transceiver module 221 further connects in wireless communication with the first transceiver module 121, receives the first translated text signal T12, and then transmits to the second text-audio converting unit 223. The second text-audio converting unit 223 converts the first translated text signal T12 into the first translated audio signal S12 and sends back to the second transceiver module 221. The second transceiver module 221 further transmits the first translated audio signal S12 to the second audio transceiver unit 213. The difference between the second and the first embodiments is that, in the second embodiment the translation is performed first, and then the text signals are wirelessly transmitted later. Therefore, when the first wireless communication device 120 and the second wireless communication device 220 connect in wireless communication with each other, the language type settings thereof must be retrieved from one to the other.

In some embodiments, the first transceiver module 121 and the second transceiver module 221 respectively include a Wi-Fi-Direct unit 1213, 2213 for connecting in wireless communication therebetween. Therefore, even the users stay in a poor network connectivity environment, both sides can still maintains their wireless communication and perform the function of interactive translation.

In some embodiments, the first wireless communication device 120 further includes a first display unit 127. The first display unit 127 electrically connects with the first transceiver module 121, and receives the second translated text signal T21 to display thereon. The second wireless communication device 220 further includes a second display unit 227. The second display unit 227 electrically connects with the second transceiver module 221, and receives the first translated text signal T12 to display thereon. In addition, the first display unit 127 and/or the second display unit 227 may be realized by a touch display device, and the user may use an input unit such a finger or a stylus touch pen to generate handwriting text signals H11/H22. Herein, the formats of the handwriting text signals H11/H22 are identical with the first text signal T11 and the second text signal T22. The first translating unit 125 electrically connects with the first display unit 127, and receives the handwriting text signal H11. The first translating unit 125 translates the handwriting text signal into the first translated text signal T12, sends to the first transceiver module 121 for transmitting to the second wireless communication device 220. On the contrary, the operations on the second wireless communication device 220 may be performed in reverse order to the above.

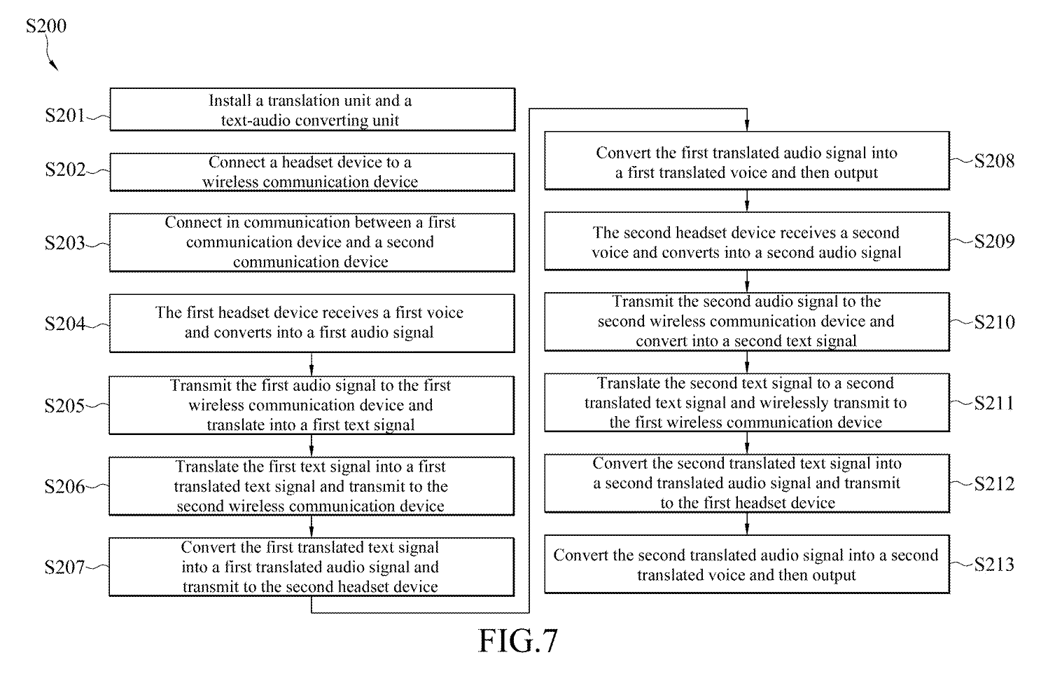

FIG. 7 illustrates an operation flowchart of the interactive translation system according to the second embodiment of the instant disclosure. As shown in FIG. 7, the operating process S200 of the interactive translation system 2 starts with Step S201, in which the first wireless communication device 120 and the second wireless communication device 220 are respectively installed with a translation unit and a text-audio converting unit. Herein, the translation unit and the text-audio converting unit may be realized by the forms of application programs, or be carried on storage card(s) installed in the first wireless communication device 120 and the second wireless communication device 220 respectively. The translation unit and the text-audio converting unit may further allow user settings of target language type(s) for translation. Next, in Step S202, connect a headset device and a wireless communication device. Herein by means of Bluetooth pairing communication or wired communication connection, the first headset device 110 connects with the first wireless communication device 120, while the second headset device 210 connects with the second wireless communication device 220. In Step S203, connect in communication between the first wireless communication device 120 and the second wireless communication device 220. The first wireless communication device 120 and the second wireless communication device 220 transmit their language type settings to each other respectively.

In Step S204, the first audio receiving unit 111 of the first headset device 110 receives the first voice V11, and acoustoelectrically converts into the first audio signal S11. In Step S205, the first audio transceiver unit 113 of the first headset device 110 transmits the first audio signal S11 to the first transceiver module 121 of the first wireless communication device 120. The first text-audio converting unit 123 of the first wireless communication device 120 receives the first audio signal S11, and converts into the first text signal T11. In Step S206, the first translating unit 115 translates the first text signal T11 into the first translated text signal T12 in a language corresponding to the language type setting of the second wireless communication device 220. Next, the first transceiver module 121 receives the first translated text signal T12 and wirelessly transmits to the second wireless communication device 220.

In Step S207, the second text-audio converting unit 223 of the second wireless communication device 220 receives the first translated text signal T12, and converts into the first translated audio signal S12. The second transceiver module 211 receives the first translated text signal S12 and transmits to the second headset device 210. In Step S208, the second audio outputting unit 215 of the second headset device 220 electroacoustically converts the first translated audio signal S12 into the first translated voice V12, and then outputs.

The steps from Step S209 to Step S213, are reverse processes approximately similar to the steps from Step S204 to Step S208, namely in the order from S208 back to Step S204. In Step S209, the second audio receiving unit 211 of the second headset device 210 receives the second voice V22, and acoustoelectrically converts into the second audio signal S22. In Step S210, the second audio transceiver unit 213 of the second headset device 210 transmits the second audio signal S22 to the second transceiver module 221 of the second wireless communication device 220. The second text-audio converting unit 223 of the second wireless communication device 220 receives the second audio signal S22, and converts into the second text signal T22. In Step S211, the second translating unit 215 translates the second text signal T22 into the second translated text signal T21. The second transceiver module 211 receives the second translated text signal T21, and wirelessly transmits to the first wireless communication device 120.

In Step S212, the first text-audio converting unit 123 of the first wireless communication device 120 receives the second translated text signal T21, and converts into the second translated audio signal S21. The first transceiver module 121 receives the second translated audio signal S21 and then transmits to the first headset device 110. In Step S113, the first audio outputting unit 115 of the first headset device 120 electroacoustically converts the second translated audio signal S21 into the second translated voice V21, and then outputs.

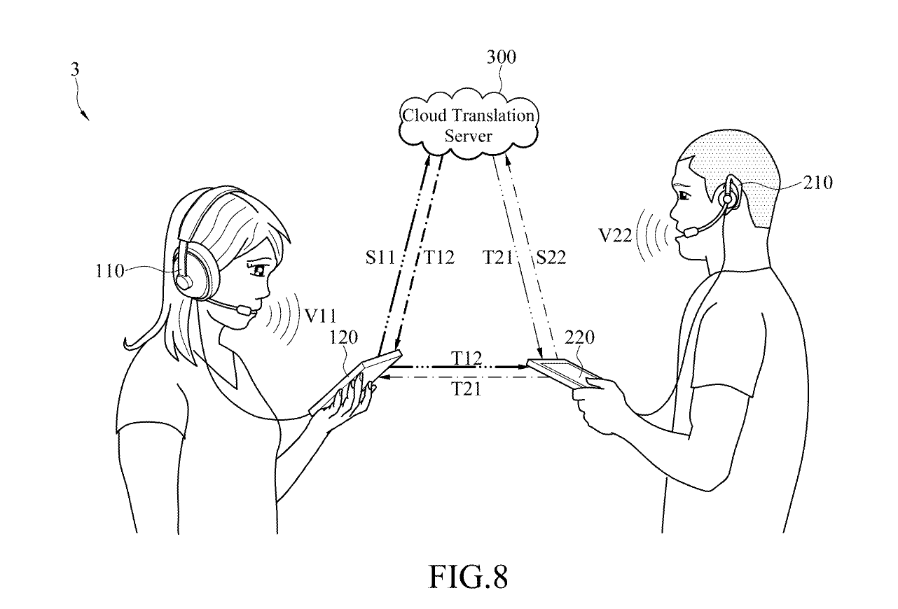

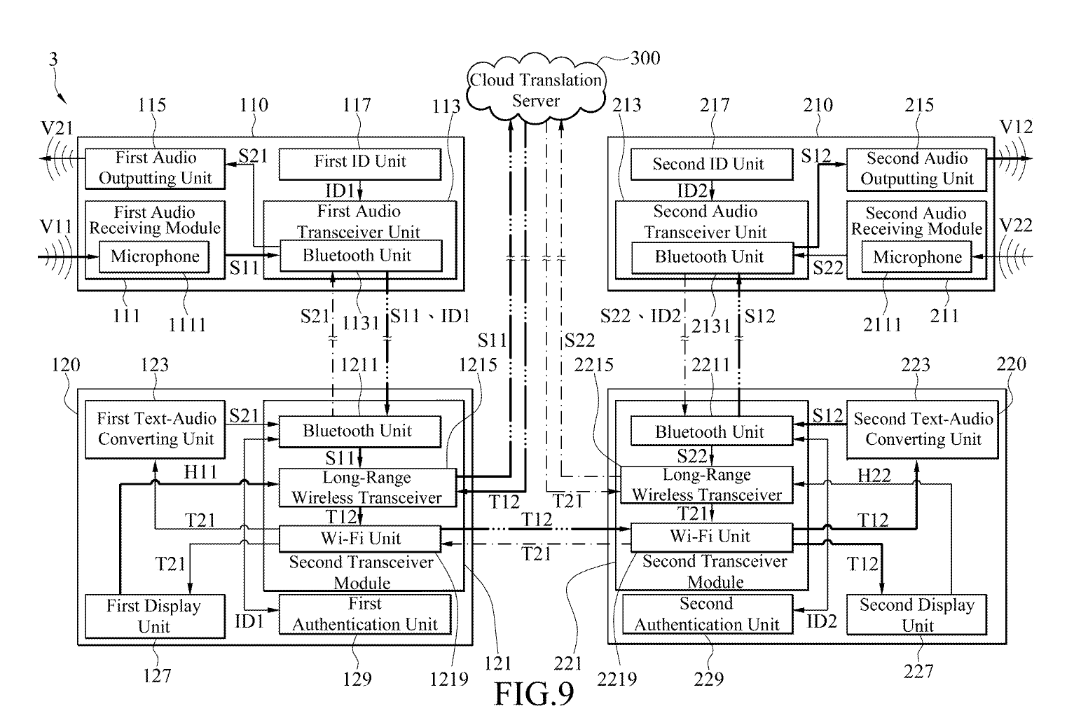

FIG. 8 illustrates an explanatory diagram regarding an operating status of an interactive translation system according to a third embodiment of the instant disclosure. FIG. 9 illustrates a block diagram of the interactive translation system according to the third embodiment of the instant disclosure. As shown in FIG. 8 and the FIG. 9, an interactive translation system 3 of the third embodiment includes a first headset device 110, a first wireless communication device 120, a second headset device 210, a second wireless communication device 220, and a cloud translation server 300. The first wireless communication device 120 connects in wireless communication with the second wireless communication device 220. The first wireless communication device 120 and the cloud translation server 300 are connected in wireless communication. And second wireless communication device 220 and the cloud translation server 300 are connected in wireless communication. In the third embodiment, the signal transmissions and the operating processes of the first headset device 110 and the second headset device 210 are similar to the first and second embodiments. The following sections mainly focus on the structures and operating processes of the first wireless communication device 120, the second wireless communication device 220 and the cloud translation server 300.

The first wireless communication device 120 includes a first transceiver module 121 and a first text-audio converting unit 123. The first transceiver module 121 connects in communication with the first audio transceiver unit 113 of the first headset device 110, and receives the first audio signal S11 for wirelessly transmitting to the cloud translation server 300. The first transceiver module 121 further wirelessly receives the first translated text signal T12 transmitted from the cloud translation server 300 and corresponding to the first audio signal S11, and then wirelessly transmits the first translated text signal T12 to the second wireless communication device 120. The first transceiver module 121 further wirelessly receives the second translated text signal T21 from the second wireless communication device 120. The first text-audio converting unit 123 electrically connects with the first transceiver module 121. The first text-audio converting unit 123 receives the second translated text signal T21, converts into the second translated audio signal S21 and then sends back to the first transceiver module 121. The first transceiver module 121 further transmits the second translated audio signal S21 to the first audio transceiver unit 113 of the first headset device 110. The cloud translation server 300 connects in wireless communication with the first transceiver module 121. The cloud translation server 300 wirelessly receives the first audio signal S11, translates and converts into the first translated text signal T12. The cloud translation server 300 further wirelessly transmits the first translated text signal T12 to the first transceiver module 121.

The second wireless communication device 220 includes a second transceiver module 221 and a second text-audio converting unit 223. The second transceiver module 221 connects in communication with the second audio transceiver unit 213 of the second headset device 210, and receives the second audio signal S22. The second transceiver module 221 further connects in communication with the cloud translation server 300 for wirelessly transmitting the second audio signal S22 to the cloud translation server 300. The cloud translation server 300 translates the second audio signal S22, converts into the second translated text signal T21 in a language corresponding to the language type setting of the first wireless communication device 120, and transmits back to the second transceiver module 221. The second transceiver module 221 further connects in wireless communication with first transceiver module 121, wirelessly receives the first translated text signal T12 and wirelessly transmits the second translated text signal T21. The second text-audio converting unit 223 electrically connects with the second transceiver module 221. The second text-audio converting unit 223 receives the first translated text signal T12, converts into the first translated audio signal S12 and then send back to the second transceiver module 221. The second transceiver module 221 further transmits the first translated audio signal S12 to the second audio transceiver unit 213.

As shown in FIG. 9, in some embodiments, the first transceiver module 121 and the second transceiver module 221 include a long-range wireless transceiver 1215, 2215 respectively. The first transceiver module 121 and the second transceiver module 221 connect in wireless communication with the cloud translation server 300 through the long-range wireless transceiver 1215, 2215 respectively. The long-range wireless transceiver 1215, 2215 may comply with the current 3G/4G long-range wireless communication protocol standards or other cellular data communication protocol standards, so as to directly connect with any available cellular data network.

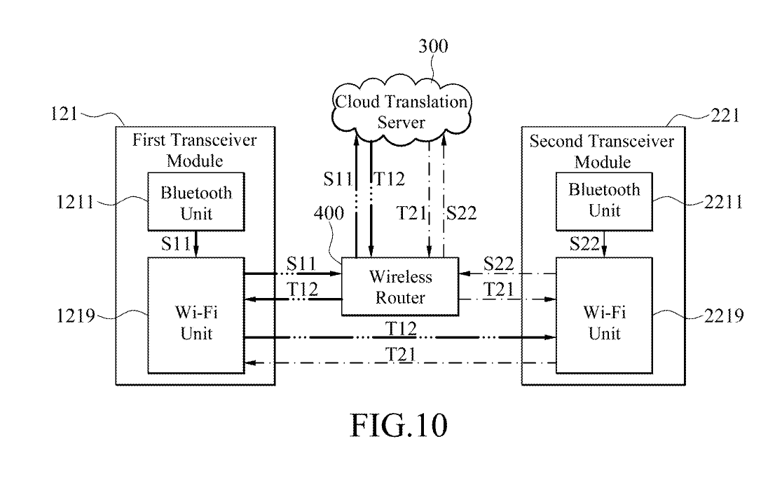

As shown in FIG. 10, in another embodiments, the first transceiver module 121 and the second transceiver module 221 include a Wi-Fi unit 1219, 2219 respectively for connecting in wireless communication therebetween. Herein, Wi-Fi units 1219, 2219 connect with each other through Wi-Fi-Direct mode. In addition, Wi-Fi unit 1219, 2219 further connects in wireless communication with a wireless router 400 respectively. The wireless router 400 connects in wireless communication with the cloud translation server 300; namely in this environment with Wi-Fi network, the wireless router 400 is available for connecting with the cellular data network. What introduced above is for illustration purposes only, and should not become limitations to the instant disclosure. For instance, both of the above two wireless communication connections may co-exist for the wireless router 400; short-range wireless transceivers such as infrared or Zigbee modules may be provided to connect in wireless communication with the wireless router 400.

In some embodiments, the first transceiver module 121 and the first audio transceiver unit 113 include a Bluetooth unit 1211, 1131 respectively for connecting in wireless communication therebetween. While in another embodiments, the first transceiver module 121 and the first audio transceiver unit 113 are connected in wired communication. For example, the first transceiver module 121 and the first audio transceiver unit 113 respectively include a connection jack 1217, 1137. The connection jack 1217, 1137 may be 3.5 mm plug jack, micro-USB electrical connector, or Lightning electrical connector. Therefore, the first headset device 110 and the first wireless communication device 120 may connect in communication with each other through an audio cable or a USB cable. What introduced above is for illustration purposes only, and should not become limitations to the instant disclosure. The second transceiver module 221 and the second audio transceiver unit 213 may include a Bluetooth unit 2211, 2131 respectively, or connect in wired communication with each other. The Bluetooth units 1211, 1131 and the Bluetooth units 2211, 2131 needs pairing with each other to connect in communication without interferences to each other.

Furthermore, as shown in FIG. 9, in some embodiments, the first headset device 110 and the second headset device 210 include a first identification unit (first ID unit) 117 and a second identification unit (second ID unit) 217 respectively, each of which generates a first identification information ID1 and a second identification information ID2. The first audio transceiver unit 113 electrically connects with the first identification unit 117. The first audio transceiver unit 113 receives the first identification information ID1 and transmits to the first transceiver module 121. The second audio transceiver unit 213 electrically connects with the second identification unit 217. The second audio transceiver unit 213 receives the first identification information ID2 and transmits to the second transceiver module 221. The first wireless communication device 120 and the second wireless communication device 220 include a first authentication unit 129 and a second authentication unit 229 respectively. The first authentication unit 129 electrically connects with the first transceiver module 121 and receives the first identification information ID1, while the second authentication unit 229 electrically connects with the second transceiver module 221 and receives the second identification information ID1. The first transceiver module 121 transmits the first audio signal S11 to the cloud translation server 300 when the first authentication unit 129 determines that the first identification information ID1 is correct. The second transceiver module 221 transmits the second audio signal S22 to the cloud translation server 300 when the second authentication unit 229 determines that the second identification information ID2 is correct.

Here in the third embodiment, the translation process is performed by the cloud translation server 300, and generally the cloud translation server 300 sets limitations to user accessibility or access fees are required. Therefore, the first identification information ID1 and the second identification information ID2 may include their language type settings and the product keys respectively.

As shown in FIG. 9, in some embodiments, the first wireless communication device 120 further includes a first display unit 127. The first display unit 127 electrically connects with the first transceiver module 121, and receives the second translated text signal T21 to display thereon. The second wireless communication device 220 further includes a second display unit 227. The second display unit 227 electrically connects with the second transceiver module 221, and receives the first translated text signal T12 to display thereon. In addition, the first display unit 127 and/or the second display unit 227 may be realized by a touch display device, and the user may use an input unit such a finger or a stylus touch pen to generate handwriting text signals H11/H22. Herein, the formats of the handwriting text signals H11/H22 are identical with the first text signal T11 and the second text signal T22. The first transceiver module 121 electrically connects with the first display unit 127. The first transceiver module 121 receives the handwriting text signal H11, and wirelessly transmits to the cloud translation server 300 to perform translation processes of the text signals.

In some embodiments, the first audio signal S11, the second audio signal S22, the first translated audio signal S12, and the second translated audio signal S21 may be provided in a uncompressed audio coding format such as .wav, or a compressed audio coding format such as .flac, .ape, .mp3, .wma, .ogg, etc. What introduced above is for illustration purposes only, and should not become limitations to the instant disclosure. As long as these formats comply with the transmission formats between the cloud translation server 300 and each of the first wireless communication device 120 and the second wireless communication device 220.

In addition, the difference between the third embodiment and the first/second embodiments, is that the cloud translation server 300 is provided for translation processes in the third embodiment. Alternatively, the third embodiment may be applied as the same way of the first embodiment, namely with the first transceiver module 121 and the second transceiver module 221 respectively transmitting the first text signal T11 and the second text signal T22 to the second transceiver module 221 and the first transceiver module 121, and with the first transceiver module 121 and the second transceiver module 221 further transmitting the second text signal T22 and the first text signal T11 to the cloud translation server 300 for translation. Furthermore, the third embodiment may be practical in combination with the first embodiment or the second embodiment. For example, under good network connectivity, the third embodiment may be applied; while under poor network connectivity, the first embodiment or the second embodiment should be applied.

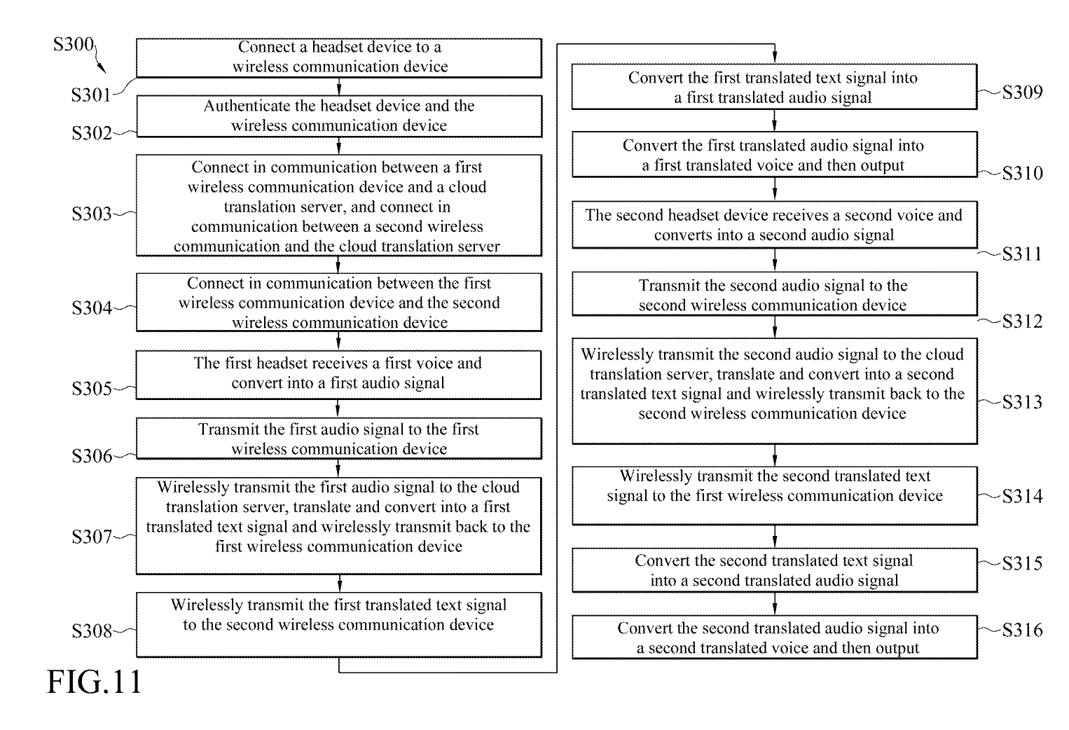

FIG. 11 illustrates an operation flowchart of the interactive translation system according to the third embodiment of the instant disclosure. As shown in FIG. 11, the operating process S300 of the interactive translation system 3 in the third embodiment starts with Step S301, which is to connect a headset device and a wireless communication device. The first headset device 110 and the second headset device 120 may connect in wireless or wired communication respectively with the first wireless communication device 120 and the second wireless communication device 120. Step S302 is to authenticate the headset device and the wireless communication device. Step S302 is optional; when this step is applied, the first headset device 110 and the second headset device 120 transmit the first identification information ID1 and the second identification information ID2 respectively to the first wireless communication device 120 and the second wireless communication device 120. The first wireless communication device 120 and the second wireless communication device 120 respectively whether the first identification information ID1 and the second identification information ID2 are correct. The subsequent steps are performed when the first identification information ID1 and the second identification information ID2 are correct, or the process stops at this step.

Step 303 is to connect in communication between the first wireless communication device 120 and the cloud translation server 300, and between the second wireless communication device 220 and the cloud translation server 300. Step S304 is to connect in communication between the first wireless communication device 120 and the second wireless communication device 220. The order of Step S303 and Step S304 may be reversed. In Step S305, the first audio receiving unit 111 of the first headset device 110 receives the first voice V11, and acoustoelectrically converts into the first audio signal S11. In Step S306, the first audio transceiver unit 113 of the first headset device 110 transmits the first audio signal S11 to the first transceiver module 121 of the first wireless communication device 120. In Step S307, the first transceiver module 121 wirelessly transmits the first audio signal S11 to the cloud translation server 300. The cloud translation server 300 translates, converts the first audio signal S11 into the first translated text signal T21, and wirelessly transmits to the first wireless communication device 120. In Step S308, the first transceiver module 121 receives the first translated text signal T12 and wirelessly transmits to the second wireless communication device 220. In Step S309, the second text-audio converting unit 223 of the second wireless communication device 220 receives the first translated text signal T12, and converts into the first translated audio signal S12. The second transceiver module 211 receives the first translated text signal S12 and transmits to the second headset device 210. In Step S310, the second audio outputting unit 215 of the second headset device 220 electroacoustically converts the first translated audio signal S12 into the first translated voice V12, and then outputs.

The steps from Step S311 to Step S316, are reverse processes approximately similar to the steps from Step S305 to S310, namely in the order from Step S305 back to S310. In Step S311, the second audio receiving unit 211 of the second headset device 210 receives the first voice V22, and acoustoelectrically converts into the second audio signal S22. In Step S312, the second audio transceiver unit 213 of the second headset device 210 transmits the second audio signal S22 to the second transceiver module 221 of the second wireless communication device 220. In Step S313, the second transceiver module 221 wirelessly transmits the second audio signal S22 to the cloud translation server 300. The cloud translation server 300 translates, converts the second audio signal S22 into the second translated text signal T12, and wirelessly transmits to the second wireless communication device 220. In Step S314, the second transceiver module 221 receives the second translated text signal T21 and wirelessly transmits to the first wireless communication device 120. In Step S315, the first text-audio converting unit 123 of the first wireless communication device 120 receives the second translated text signal T21, and converts into the second translated audio signal S21. The first transceiver module 111 receives the second translated audio signal S21 and transmits to the first headset device 110. In Step S316, the first audio outputting unit 115 of the first headset device 120 electroacoustically converts the second translated audio signal S21 into the second translated voice V21, and then outputs.

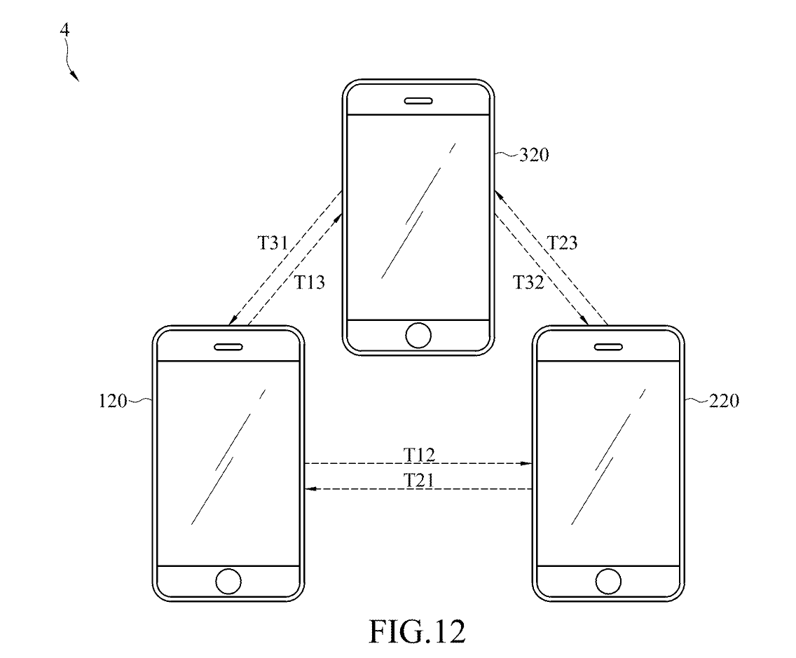

FIG. 12 illustrates an explanatory diagram regarding an operating status of an interactive translation system according to a fourth embodiment of the instant disclosure. As shown in FIG. 12, the interactive translation system 4 may provide bidirectional translation or even multi-directional translation. For instance, the interactive translation system 4 includes a first wireless communication device 120, a second wireless communication device 220 and a third wireless communication device 320. The headset devices are similar to those mentioned above and omitted herein. The first wireless communication device 120 wirelessly transmits the second translated text signal T12 to the second wireless communication device 220, and transmits a third translated text signals T13 to the third wireless communication device 320. The second wireless communication device 220 transmits the first translated text signal T21 to the first wireless communication device 120, and transmits a fourth translated text signals T23 to the third wireless communication device 320. The third wireless communication device 320 transmits a fifth translated text signals T31 to the first wireless communication device 120, and transmits a sixth translated text signals T32 to the second wireless communication device 220. In addition, the second translated text signal T12 may be translated optionally. Such approach is much suitable for the multinational, multilingual conversations occurring in youth hotels, backpacker hotels or student dorms.

In the embodiments introduced above, through connecting in communication between the first wireless communication device and the second wireless communication device, as well as transmitting by text signals, the interactive translation system lowers the data quantity during transmissions and accelerates the transmission speed, thereby achieving the effects of instant translation. Furthermore, even the system is applied under poor network connectivity, smaller files transmission of text signals can still be well performed without being affected.

What is claimed is:

1. An interactive translation system, comprising:
a first headset device, including a first audio receiving unit, a first audio transceiver unit and a first audio outputting unit, the first audio receiving unit receiving a first voice and converting into a first audio signal, the first audio transceiver unit electrically connecting with the first audio receiving unit, the first audio transceiver unit receiving and transmitting the first audio signal, the first audio transceiver unit further receiving externally a second translated audio signal, the first audio outputting unit electrically connecting with the first audio transceiver unit, the first audio outputting unit receiving the second translated audio signal, converting into a second translated voice and then outputting, wherein the first voice and the second translated voice are of languages identical with or different from each other;
a first wireless communication device, including a first transceiver module, a first text-audio converting unit and a first translating unit, the first transceiver module connecting in communication with the first audio transceiver unit and receiving the first audio signal, the first text-audio converting unit electrically connecting with the first transceiver module and receiving the first audio signal, the first text-audio converting unit converting the first audio signal into a first text signal and sending back to the first transceiver module for wireless transmitting, the first transceiver module further wirelessly and receiving externally a second text signal, the first translating unit electrically connecting with the first transceiver module, the first translating unit receiving the second text signal and translating into a first translated text signal, the first text-audio converting unit further electrically connecting with the first translating unit and receiving the first translated text signal, the first text-audio converting unit converting the first translated text signal into the second translated audio signal and sending back to the first transceiver module, the first transceiver module further transmitting the second translated audio signal to the first audio transceiver unit;
a second headset device, including a second audio receiving unit, a second audio transceiver unit and a second audio outputting unit, the second audio receiving unit receiving a second voice and converting into a second audio signal, the second audio transceiver unit electrically connecting with the second audio receiving unit, the second audio transceiver unit receiving and transmitting the second audio signal, the second audio transceiver unit further receiving externally a first translated audio signal, the second audio outputting unit electrically connecting with the second audio transceiver unit, the second audio outputting unit receiving the first translated audio signal, converting into a first translated voice and outputting, wherein the second voice and the first translated voice are of languages identical with or different from each other; and
a second wireless communication device, including a second transceiver module, a second text-audio converting unit and a second translating unit, the second transceiver module connecting in communication with the second audio transceiver unit and receiving the second audio signal, the second text-audio converting unit electrically connecting with the second transceiver module and receiving the second audio signal, the second text-audio converting unit converting the second audio signal into the second text signal and sending back to the second transceiver module for wireless transmitting, the second transceiver module further connecting in wireless communication with the first transceiver module and receiving the first text signal, the second translating unit electrically connecting with the second transceiver module, the second translating unit receiving the first text signal and translating into a first translated text signal, the second text-audio converting unit electrically connecting with the second translating unit and receiving the first translated text signal, the second text-audio converting unit converting the first translated text signal into the first translated audio signal and sending back to the second transceiver module, the second transceiver module transmitting the first translated audio signal to the first audio transceiver unit.

2. The interactive translation system of claim 1, wherein the first transceiver module and the second transceiver module respectively comprises a Wi-Fi-direct unit for connecting in wireless communication therebetween.

3. The interactive translation system of claim 1, wherein the first transceiver module and the first audio transceiver unit respectively comprises a Bluetooth unit for connecting in wireless communication therebetween.

4. The interactive translation system of claim 1, wherein the first transceiver module and the first audio transceiver unit are connected in wired communication.

5. The interactive translation system of claim 1, wherein the first wireless communication device further comprises a first display unit to display the second translated text signal, and the second wireless communication device further comprises a second display unit to display the first translated text signal.

6. The interactive translation system of claim 5, wherein the first display unit is a touch display device to generate a handwriting text signal, the first transceiver module electrically connects with the first display unit, and the first transceiver module receives the handwriting text signal and wirelessly transmits to the second transceiver module.

7. A interactive translation system, comprising:
a first headset device, including a first audio receiving unit, a first audio transceiver unit and a first audio outputting unit, the first audio receiving unit receiving a first voice and converting into a first audio signal, the first audio transceiver unit electrically connecting with the first audio receiving unit, the first audio transceiver unit receiving and transmitting the first audio signal, the first audio transceiver unit further receiving externally a second translated audio signal, the first audio outputting unit electrically connecting with the first audio transceiver unit, the first audio outputting unit receiving the second translated audio signal, converting into a second translated voice and then outputting, wherein the first voice and the second translated voice are of languages identical with or different from each other;
a first wireless communication device, including a first transceiver module, a first text-audio converting unit and a first translating unit, the first transceiver module connecting in communication with the first audio transceiver unit and receiving the first audio signal, the first text-audio converting unit electrically connecting with the first transceiver module and receiving the first audio signal, the first text-audio converting unit converting the first audio signal into a first text signal, the first translating unit electrically connecting with the first text-audio converting unit, receiving the first text signal and then translating into a first translated text signal, the first transceiver module further electrically connecting with the first translating unit, receiving the first translated text signal and then transmitting wirelessly, the first transceiver module further receiving externally a second translated text signal and transmitting to the first text-audio converting unit, the first text-audio converting unit converting the second translated text signal into the second translated audio signal and send back to the first transceiver module, the first transceiver module further transmitting the second translated audio signal to the first audio transceiver unit;
a second headset device, including a second audio receiving unit, a second audio transceiver unit and a second audio outputting unit, the second audio receiving unit receiving a second voice and converting into a second audio signal, the second audio transceiver unit electrically connecting with the second audio receiving unit, receiving the second audio signal and then transmitting, the second audio transceiver unit further receiving externally a first translated audio signal, the second audio outputting unit electrically connecting with the second audio transceiver unit, the second audio outputting unit receiving the first translated audio signal, converting into a first translated voice and then outputting, wherein the second voice and the first translated voice are of languages identical with or different from each other; and
a second wireless communication device, including a second transceiver module, a second text-audio converting unit and a second translating unit, the second transceiver module connecting in communication with the second audio transceiver unit and receiving the second audio signal, the second text-audio converting unit electrically connecting with the second transceiver module, receiving the second audio signal and converting into a second text signal, the second translating unit electrically connecting with the second text-audio converting unit, receiving the second text signal and then translating into the second translated text signal, the second transceiver module further electrically connecting with the second translating unit, receiving the second translated text signal and then wirelessly transmitting to the second transceiver module, the second transceiver module further connecting in wireless communication with the first transceiver module, receiving the first translated text signal and then transmitting to the second text-audio converting unit, the second text-audio converting unit converting the first translated text signal into the first translated audio signal and sending back to the second transceiver module, the second transceiver module further transmitting the first translated audio signal to the second audio transceiver unit.

8. The interactive translation system of claim 7, wherein the first transceiver module and the second transceiver module respectively comprises a Wi-Fi-direct unit for connecting in wireless communication therebetween.

9. The interactive translation system of claim 7, wherein the first transceiver module and the first audio transceiver unit respectively comprises a Bluetooth unit for connecting in wireless communication therebetween.

10. The interactive translation system of claim 7, wherein the first transceiver module and the first audio transceiver unit are connected in wired communication.

11. The interactive translation system of claim 7, wherein the first wireless communication device further comprises a first display unit to display the second translated text signal, and the second wireless communication device further comprises a second display unit to display the first translated text signal.

12. The interactive translation system of claim 11, wherein the first display unit is a touch display device to generate a handwriting text signal, the first translating unit electrically connects with the first display unit and receives the handwriting text signal, and the first translating unit translates the handwriting text signal into the first translated text signal and then transmits to the first transceiver module.

13. An interactive translation system, comprising:
a first headset device, including a first audio receiving unit, a first audio transceiver unit and a first audio outputting unit, the first audio receiving unit receiving a first voice and converting into a first audio signal, the first audio transceiver unit electrically connecting with the first audio receiving unit, the first audio transceiver unit receiving and transmitting the first audio signal, the first audio transceiver unit further receiving externally a second translated audio signal, the first audio outputting unit electrically connecting with the first audio transceiver unit, the first audio outputting unit receiving the second translated audio signal, converting into a second translated voice and then outputting, wherein the first voice and the second translated voice are of languages identical with or different from each other;
a first wireless communication device, including a first transceiver module and a first text-audio converting unit, the first transceiver module connecting in communication with the first audio transceiver unit, and receiving the first audio signal for wireless transmitting, the first transceiver module further wirelessly receiving and wirelessly transmitting a first translated text signal corresponding to the first audio signal, the first transceiver module also wirelessly receiving a second translated text signal, the first text-audio converting unit electrically connecting with the first transceiver module, the first text-audio converting unit receiving the second translated text signal, converting into a second translated audio signal and sending back to the first transceiver module, the first transceiver module further transmitting the second translated audio signal to the first audio transceiver unit;
a cloud translation server, connecting in wireless communication with the first transceiver module, the cloud translation server wirelessly receiving the first audio signal, translating and converting into the first translated text signal, the cloud translation server further wireless transmitting the first translated text signal to the first transceiver module;
a second headset device, including a second audio receiving unit, a second audio transceiver unit and a second audio outputting unit, the second audio receiving unit receiving a second voice and converting into a second audio signal, the second audio transceiver unit electrically connecting with the second audio receiving unit, the second audio transceiver unit receiving and transmitting the second audio signal, the second audio transceiver unit further receiving externally a first translated audio signal, the second audio outputting unit electrically connecting with the second audio transceiver unit, the second audio outputting unit receiving the first translated audio signal, converting into a first translated voice and then outputting, wherein the second voice and the first translated voice are of languages identical with or different from each other; and
a second wireless communication device, including a second transceiver module and a second text-audio converting unit, the second transceiver module connecting in communication with the second audio transceiver unit and receiving the second audio signal, the second transceiver module further connecting in communication with the cloud translation server for wireless transmitting the second audio signal to the cloud translation server, the cloud translation server translating and converting the second audio signal into the second translated text signal and then sending back to the second transceiver module, the second transceiver module further connecting in wireless communication with the first transceiver module, the second transceiver module wirelessly receiving the first translated text signal and wirelessly transmitting the second translated text signal, the second text-audio converting unit electrically connecting with the second transceiver module, the second text-audio converting unit receiving the first translated text signal, converting into a first translated audio signal and then sending back to the second transceiver module, the second transceiver module transmitting the first translated audio signal to the second audio transceiver unit.

14. The interactive translation system of claim 13, wherein the first transceiver module and the second transceiver module respectively comprises a Wi-Fi unit for connecting in wireless communication therebetween.

15. The interactive translation system of claim 14, wherein the Wi-Fi unit connects in wireless communication with a wireless router, and the wireless router connects in wireless communication with the cloud translation server.

16. The interactive translation system of claim 13, wherein the first transceiver module and the second transceiver module respectively comprises a long-range wireless transceiver, and the long-range wireless transceiver connects in wireless communication with the cloud translation server.

17. The interactive translation system of claim 13, wherein the first transceiver module and the first audio transceiver unit respectively comprises a Bluetooth unit for connecting in wireless communication therebetween.

18. The interactive translation system of claim 13, wherein the first transceiver module and the first audio transceiver unit are connected in wired communication.

19. The interactive translation system of claim 13, wherein the first headset device and the second headset device respectively comprises a first identification unit and a second identification unit, which respectively generates a first identification information and a second identification information, the first audio transceiver unit electrically connecting with the first identification unit, the first audio transceiver unit receiving the first identification information and transmitting to the first transceiver module, the second audio transceiver unit electrically connecting with the second identification unit, the second audio transceiver unit receiving the first identification information and transmitting to the second transceiver module, the first wireless communication device and the second wireless communication device respectively comprising a first authentication unit and a second authentication unit, the first authentication unit electrically connecting with the first transceiver module and receiving the first identification information, the second authentication unit electrically connecting with the second transceiver module and receiving the second identification information, the first transceiver module transmitting the first audio signal to the cloud translation server when the first authentication unit determines that the first identification information is correct, the second transceiver module transmitting the second audio signal to the cloud translation server when the second authentication unit determines that the second identification information is correct.

20. The interactive translation system of claim 13, wherein the first wireless communication device further comprises a first display unit to display the second translated text signal, and the second wireless communication device further comprises a second display unit to display the first translated text signal.

21. The interactive translation system of claim 20, wherein the first display unit is a touch display device to generate a handwriting text signal, the first transceiver module electrically connecting with the first display unit, the first transceiver module receiving and wirelessly transmitting the handwriting text signal to the cloud translation server.

22. The interactive translation system of claim 13, wherein the first audio signal, the second audio signal, the first translated audio signal and the second translated audio signal are of an uncompressed audio coding format or a compressed audio coding format.

23. The interactive translation system of claim 13, wherein the first audio receiving unit and the second audio receiving unit respectively comprises a microphone, wherein the microphone is a micro-electromechanical systems microphone or a bone-conduction microphone.
